(19) United States
(12) Patent Application Publication
(10) Pub. No.: US 2021/0285113 A1
(43) Pub. Date: Sep. 16, 2021

(54) PROCESS THAT CAN WITHSTAND HIGH CURRENTS, FOR PRODUCING AMMONIA

(71) Applicant: Siemens Aktiengesellschaft, München (DE)

(72) Inventors: Bernhard Schmid, Düren (DE); Günter Schmid, Hemhofen (DE); Christian Reller, Minden (DE); Dan Taroata, Erlangen (DE)

(21) Appl. No.: 17/255,698

(22) PCT Filed: Jun. 24, 2019
(86) PCT No.: PCT/EP2019/066678

§ 371 Date: Dec. 23, 2020

(30) Foreign Application Priority Data
Jun. 25, 2018 (DE) 10 2018 210 304.6

(51) Int. Cl. C25B 1/27; C25B 11/031; C25B 1/50; C25B 15/08; C25B 9/19; C25C 1/02; C25C 3/02; C25C 3/04; C25C 3/06; C25C 7/00; C01B 21/06; C01B 21/072

(52) U.S. Cl. CPC C25B 1/27; C25B 11/031; C25B 1/50; C25B 15/08; C25B 9/19; C25C 1/02; C01B 21/0722; C25C 3/04; C25C 3/06; C25C 7/00; C01B 21/061; C01B 21/0612; C01B 21/0615; C25C 3/02

(57) ABSTRACT

A process for producing ammonia and an apparatus for producing ammonia are disclosed herein. The process includes: the electrolytic production of a metal at a cathode of an electrolysis cell, wherein the metal is selected from Li, Mg, Ca, Sr, Ba, Zn, Al and/or alloys and/or mixtures thereof; production of a nitride of the metal M by reaction of the electrolytically produced metal with a gas including nitrogen; introduction of the nitride of the metal M into the electrolysis cell (e.g., into an anode chamber of the electrolysis cell); and reaction of the nitride of the metal M at an anode of the electrolysis cell to produce ammonia.

The present patent document is a § 371 nationalization of PCT Application Serial No. PCT/EP2019/066678, filed Jun. 24, 2019, designating the United States, which is hereby incorporated by reference, and this patent document also claims the benefit of German Patent Application No. 10 2018 210 304.6, filed Jun. 25, 2018, which is also hereby incorporated by reference.

### TECHNICAL FIELD

The present disclosure relates to a process for preparing ammonia, and to an apparatus for preparing ammonia.

### BACKGROUND

In the period around 1910-1920, the Haber-Bosch process for preparation of ammonia from atmospheric nitrogen and hydrogen was developed.

Nowadays, more than 130 Mt/year are prepared. The hydrogen is typically prepared here using energy from fossil fuels. However, it would be possible to use electrochemical methods for preparation of hydrogen with wind or solar energy, for example, in order to replace this hydrogen from fossil fuels in the Haber-Bosch process.

Even though the reaction in the Haber-Bosch process is exothermic, the kinetics are very slow.

3/2H₂+½N₂→NH₃-46 lkJ/mol

However, main disadvantages of the Haber-Bosch process as part of a dynamic storage method, which arise primarily from the high bond energy of the dinitrogen molecule, are: (a.) high temperatures (˜450-550° C.); (b.) a high pressure (˜250-350 bar); (c.) low conversion rates in a single pass through the catalyst (˜20%); and (d.) repeated decompressions and repeated heating in order to accomplish the production cycle.

There is therefore a need to improve or replace this complex and not particularly efficient process.

In this regard, there has been development work for many years on electrochemical methods that reduce nitrogen to nitride or ammonia at the cathode. However these all have the disadvantage that the Faraday efficiency of ammonia is vanishingly small at industrially utilizable current densities above 100-300 mA/cm².

The scientific literature has examined multiple methods of integrating the reaction

N₂+3H₂O→2NH₃+1.5O₂

into an electrolysis cell, for example via the following nitride sequences for which the metals are prepared electrochemically, nitride is formed thermally, and the hydrolysis is likewise effected thermally.

!TABLE 1
Nitride preparation in the nitride sequence

| | |
|---|---|
| | Proportion by weight of |
| Reaction | nitrogen in the product |

| | | |
|---|---|---|
| Lithium | 6 Li + N₂ → 2 Li₃N | 40.20% |
| Magnesium | 3 Mg + N₂ → Mg₃N₂ | 27.74% |
| Calcium | 3 Ca + N₂ → Ca₃N₂ | 18.89% |

TABLE 2
Ammonia preparation in the nitride sequence

| Alkali metal/ | | |
|---|---|---|
| alkaline earth | | Enthalpy of |
| metal | Reaction | reaction |
| Lithium | Li₃N + 3 H₂O → 3 LiOH + NH₃ | −444 kJ/mol |
| Magnesium | Mg₃N₂ + 3 H₂O → 3 MgO + 2 NH₃ (*1) | −708 kJ/mol |
| Calcium | Ca₃N₂ + 3 H₂O → 3 CaO + 2 NH₃ (*2) | −840 kJ/mol |

(*1): decomposition temperature of Mg(OH)₂: 350° C.
(*2): decomposition temperature of Ca(OH)₂: 550° C.

For example, a direct electrochemical conversion of nitrogen and hydrogen to ammonia in molten salt electrolytes with gas diffusion electrodes has been discussed.

The main disadvantages of this method are the design with duplicate gas diffusion electrodes, and the low conversion rates at the cathode.

At the anode, the hydrogen may make the metallic electrodes brittle through hydride formation in the first act, which later separates into an electron and a proton.

Various alternative routes as variations of the above reaction are known, for example, as described in T. Murakami et al./Electrochimica Acta 50 (2005) 5423-5426. The LiCl/KCl electrolyte and nitride ion formation correspond to those in the above method of direct electrochemical conversion of nitrogen and hydrogen to ammonia. Interestingly, however, what are provided here are protons (not hydride), through introduction of steam. Therefore, ammonia is formed at the cathode. Oxygen and not chlorine is formed at the anode. If the anode includes carbon, there will be at least partial formation of CO₂. Here too, the preparation of ammonia takes place from the melt.

In such methods, it is possible to achieve current efficiencies (Faraday efficiencies; FE) of up to 72% with an academic construction. However, the electrolysis cells were purely experimental, and so no attention at all was paid to improve system efficiency by optimizing the electrolysis conditions. The current densities were also low at around 5 mA/cm² (T. Murakami et al./Electrochimica Acta 50 (2005) 5423-5426). Commercial molten salt electrolyzers may work at current densities up to 600 mA/cm². An alternative electrolyte is lithium hydroxide. However, temperatures above 400° C. are required here to drive the process, and the introduction of oxide species will eventually destroy the electrolyte owing to accumulation.

So far, electrolysis cells at the research level have been described, which is converted to a stack for industrial use. High-temperature stacks with gaseous substrates and products are obtainable in the field of solid-oxide fuel cells (SOFCs, oxide ceramic fuel cells) or solid-oxide electrolysis cells (SOECs, oxide ceramic electrolysis cells) up to a scale of 20 kW. However, larger modules are not commercially available to date on account of the high temperatures and brittle ceramics.

It is difficult to conceive of stacks with liquid salt melts and two gas diffusion electrodes that work within a temperature range around and above 400° C. In the course of cooling, crystallizing salt may additionally destroy the stack.

As well as the electrolytes composed of molten salt, H⁺-conducting membranes have been used. However, significant ammonia synthesis has been observed only at temperatures above 500° C.

Lithium nitride seems to be an important intermediate for reducing nitrogen and ultimately forming NH₃ by protonation. Lithium nitride also forms at room temperature. Tsuneto et al., Journal of Electroanalytical Chemistry, 367 (1994) 183-188, describe a low-temperature synthesis of ammonia at moderate pressure in a lithium battery-like environment with lithium triflate electrolyte in an ether as solvent. The most efficient cathode for preparation of ammonia is composed of iron, having significant comparability with the catalyst in the Haber-Bosch process (FE 59% at 50 bar). Proton sources here are critical and compatible with the electrochemistry, because there is a risk of side reactions. Nevertheless, these low-temperature reactions have the potential to prepare ammonia at low temperature and moderate pressure.

However, there is still a need for an efficient electrolytic preparation of ammonia at low temperatures, which is also scalable.

### SUMMARY AND DESCRIPTION

In this regard, an electrochemical process sequence is disclosed herein for preparation of ammonia, which may be effected at comparatively low temperature, for example, a melt temperature of an electrolyte based on a salt melt, and is also scalable on account of a simple construction of the electrolysis cell.

In a first aspect, the present disclosure relates to a process for preparing ammonia. The process includes: electrolytically preparing a metal M at a cathode of an electrolysis cell, where M is selected from Li, Mg, Ca, Sr, Ba, Zn, Al, and/or alloys and/or mixtures thereof; preparing a nitride of the metal M by reacting the electrolytically prepared metal M with a gas including nitrogen; and introducing the nitride of the metal M into the electrolysis cell, (e.g., into an anode space of the electrolysis cell), and converting the nitride of the metal M to ammonia at an anode of the electrolysis cell.

The process of the disclosure includes the combination of an electrochemical process act with a thermochemical process act for preparation of ammonia with high conversion rates that cannot be achieved either by the pure electrochemical process or by the pure Haber-Bosch process, because the nitrogen-reducing cathode has a current-limiting effect in electrochemical methods, and only about 15% of the gas mixture is converted during passage through the catalyst bed in the Haber-Bosch process.

The limitation of current in the electrochemical methods is circumvented by not reducing nitrogen at the cathode but depositing a nitride-forming and/or -stabilizing metal, which is then converted to the nitride outside the electrolyzer, especially at high temperatures by virtue of the highly exothermic reaction. The cations needed for this purpose are especially part of the electrolyte:

M→Mⁿ⁺ne⁻

n−1(Li), 2(Mg, Ca, Sr, Ba, Zn), 3(Al).

Furthermore, by virtue of the closed metal circuit, it is possible to avoid the workup of oxygen-containing by-products.

Also disclosed is an apparatus for preparation of ammonia. The apparatus includes an electrolysis cell having: a cathode space including a cathode for preparation of a metal M, where M is selected from Li, Mg, Ca, Sr, Ba, Zn, Al, and/or alloys and/or mixtures thereof, where the cathode is designed to prepare a metal M; a separation apparatus set up to separate the metal M from the cathode; a first removal apparatus for the metal M which is connected to the cathode space and designed to remove the metal M from the electrolysis cell; a second feed device for a nitride of the metal M, which is set up to feed a nitride of the metal M to the electrolysis cell, (e.g., an anode space of the electrolysis cell); and an anode space including an anode for preparation of ammonia from the nitride of the metal M, where the anode is designed to prepare ammonia from the nitride of the metal M. The apparatus also includes a preparation apparatus for preparation of a nitride of the metal M by reacting the electrolytically prepared metal M with a gas including nitrogen. The preparation apparatus includes: a reaction apparatus for reacting the metal M with a gas including nitrogen, designed to react the metal M with a gas including nitrogen; a first feed device for the metal M, designed to feed the metal M to the apparatus for conversion of the metal M; and a second removal device for a nitride of the metal M, designed to remove a nitride of the metal M from the apparatus for conversion of the metal M.

Further aspects of the present disclosure may be inferred from the dependent claims and the detailed description.

### BRIEF DESCRIPTION OF THE FIGURES

The appended drawings are intended to illustrate embodiments of the present disclosure and impart further understanding thereof. In association with the description, they serve to elucidate concepts and principles of the disclosure. Other embodiments and many of the advantages mentioned are apparent with regard to the drawings. The elements of the drawings are not necessarily shown true to scale relative to one another. Elements, features, and components that are the same, have the same function and the same effect are each given the same reference numerals in the figures of the drawings, unless stated otherwise.

FIG. 1 schematically depicts an example of an apparatus.

FIG. 2 depicts an example of the correlation of the flame temperature on combustion of metals as a function of the reaction gas/fuel ratio.

FIGS. 3 to 6 depict examples of phase diagrams of various salt mixtures that may be employed as base electrolytes in the process.

### DETAILED DESCRIPTION

### Definitions

Unless defined differently, technical, and scientific expressions used herein have the same meaning as commonly understood by a person skilled in the art in the field of the disclosure.

Figures given in the context of the present disclosure relate to % by weight, unless stated differently or apparent from the context. In the gas diffusion electrode of the disclosure, the percentages by weight add up to 100% by weight.

Gas diffusion electrodes (GDEs) may be electrodes in which there are liquid, solid, and gaseous phases, and where, in particular, a conductive catalyst may catalyze an electrochemical reaction between the liquid phase and the gaseous phase.

Different designs are possible, for example as a porous “all-active material catalyst”, optionally with auxiliary layers for adjustment of hydrophobicity; or as a conductive porous support to which a catalyst may be applied in a thin layer.

In the context of this disclosure, a gas diffusion electrode (GDE) is especially a porous electrode within which gases may move through diffusion. It may be designed, for example, to separate a gas space and an electrolyte space from one another.

Standard pressure is 101 325 Pa=1.01325 bar.

In a first aspect, the present disclosure relates to a process for preparing ammonia. The method includes: electrolytically preparing a metal M at a cathode of an electrolysis cell, where M is selected from Li, Mg, Ca, Sr, Ba, Zn, Al, and/or alloys and/or mixtures thereof; preparing a nitride of the metal M by reacting the electrolytically prepared metal M with a gas including nitrogen; and introducing the nitride of the metal M into the electrolysis cell, (e.g., into an anode space of the electrolysis cell), and converting the nitride of the metal M to ammonia at an anode of the electrolysis cell.

The process of the disclosure may be performed with the apparatus of the disclosure.

It is a feature of the process that nitrides are produced as intermediates outside the electrolysis cell from a nitride-forming metal M in conventional thermal processes. The nitride is returned to the electrolysis cell, where it is protonated to give ammonia, especially with a hydrogen-depolarized anode. The metal circuit here is intrinsically closed, and it is possible to form metal M again in the electrolysis cell from the metal cations after formation of ammonia. The overall equation corresponds to the Haber-Bosch process. All reactions especially proceed quantitatively, such that no cycling of the process gas is necessary.

In the process, the electrolytic preparation of the metal M, where M is selected from Li, Mg, Ca, Sr, Ba, Zn, Al, and/or alloys and/or mixtures thereof, (e.g., Mg, Ca, Sr, Ba, Al and/or alloys and/or mixtures thereof), at the cathode of the electrolysis cell is not particularly restricted.

In particular embodiments, the electrolytic preparation of the metal M is effected by deposition of the metal M at the cathode, and the metal is separated from the cathode, for example, before being supplied to the reaction with a gas including nitrogen.

The alkali metals and alkaline earth metals Li, Mg, Ca, Sr, and Ba, and also Zn, may be prepared, for example, by electrolysis of a salt melt. In the case of lithium, for example, the electrolyte may include a eutectic mixture of LiCl/KCl or include such a eutectic mixture of LiCl/KCl.

For the other metals M, corresponding salt melts likewise exist, some of which are also mentioned by way of example in the examples disclosed herein, namely KCl/MgCl₂, BaCl₂/LiCl, and BaCl₂/MgCl₂.

In particular embodiments, the melting point of an electrolyte in the electrolysis cell, especially a salt melt, in the process of the disclosure is lower, especially much lower, than the decomposition temperature of ammonia, (e.g., less than 630° C., less than 610° C., less than 600° C., less than 550° C., less than 500° C., less than 450° C., or even less than 400° C.). This is the case, for example, for LiCl/KCl and, with restriction, for example, also for KCl/MgCl₂, BaCl₂/LiCl and BaCl₂/MgCl₂.

The salt melts may of course also include the corresponding nitride of the metal M and further additions, for example for melting point reduction, etc.

Alternative solvent-based electrolytes with cations of the metal M are also conceivable, where the solvent is not particularly restricted and is organic, for example, and/or ionic liquids. Because the nitride ion, however, is one of the strongest bases, the electrolytes must be stable thereto. If such electrolytes are used, lower electrolysis temperatures down to below 100° C. are also possible, for example even down to room temperature of 20-25° C.

In particular embodiments, the electrolyte in the electrolysis cell includes a salt melt, an ionic liquid and/or a solution of salts in an organic solvent including ions of the metal M. More particularly, the electrolyte in the electrolysis cell includes the nitride of the metal M, at least in an anode space of the electrolysis cell.

The nitride may be supplied to the electrolyte externally, e.g., directly from the preparation of a nitride of the metal M, (e.g., a thermochemical method of nitride preparation), and is especially not prepared in the electrolysis cell itself.

The introduction of the nitride of the metal M into the electrolysis cell, or the supply thereof, is not particularly restricted, especially in the case of homogeneous electrolytes, but may be effected in the anode environment or an anode space, if one is present, for example when a separator separates the electrolysis cell into an anode space including anode and a cathode space including cathode. Simultaneously with the nitride supply, the cation of the metal M is again supplied to the electrolyte here, and may then be reduced again to the metal M at the cathode. This procedure completely closes the metal circuit, such that the metal M serves merely as mediator for nitrogen reduction and, viewed overall, is not consumed.

After the preparation of the metal M, the metals deposited may be separated from the electrode in different ways. Solid metals may be separated mechanically, for example. It is particularly easy, and hence particularly used in the process, to separate the metals off when they are in liquid form, meaning that the electrolysis is performed above the melting point thereof. In particular embodiments, alloys of the metal M are provided because these alloys have a lower melting point. According to the density of the metal and of the electrolyte, the metal may then settle out above or below the electrolyte and hence be drawn off easily.

Examples of electrolysis cells in which a corresponding separation of liquid metal is possible are the Downs or Castner cell, or the cells for aluminum electrolysis, and so, in particular embodiments, the electrolysis cell in the process may be a Downs cell, a Castner cell and/or a corresponding electrolysis cell in an aluminum electrolysis, which is not particularly restricted. The Downs cell, the Castner cell or any electrolysis cell for aluminum production are known to the person skilled in the art and are not particularly restricted. The individual cell types may vary significantly in their dimensions and serve merely for illustration of the mode of operation of the cell. In principle, two states of operation are conceivable for the separation of the liquid metal M:

1) In one state, the metal has a lower density than the electrolyte and therefore floats on top. For the process, a Downs cell, for example, is then suitable, because the ammonia formed at the anode may be drawn off analogously to chlorine, for example with Li as metal M.

2) In a second state, the metal has a higher density than the electrolyte and therefore sinks to the bottom of the electrolysis cell. Therefore, a horizontal electrode as in the case of aluminum electrolysis is advantageous here, for example, with Ba as metal M.

In a further configuration, the cathode is made porous, in order to be able to draw off the liquid metal M in the interior of the electrode. Here too, the further configuration of the cathode is not particularly restricted, and it is possible, for example, to provide a pump for suction of the metal M with an appropriate first removal apparatus. In this case, in particular embodiments, it is thus possible to separate off the metal M in liquid form. The porosity of the electrode here may again be matched to the metal M to be prepared, for example with regard to the density thereof, surface tension on the cathode, etc.

The material of the cathode of the electrolysis cell is not particularly restricted. In particular embodiments, however, the cathode includes the metal M, (e.g., when the metal is separated off in solid form), and/or includes a metal and/or a material such as carbon, etc., which has sufficient conductivity and is in solid form at the electrolysis temperature. Because this temperature depends on the metal M, according to the metal M, various materials are therefore also conceivable for the cathode, which, furthermore, are not subject to any further restriction. For example, pure iron is also suitable. By contrast, lithium forms an alloy with copper, for example, and would therefore only be of limited suitability for deposition of lithium. Correspondingly, the cathode may be matched to the metal M. As soon as a film of the metal forms on the electrode, the overvoltage of the metal on this electrode thus conditioned is 0 by definition.

As shown by Table 3, current densities above 300-500 mA/cm² are possible without difficulty. In particular embodiments, the electrolytic preparation of the metal M is effected at the cathode of the electrolysis cell with a current density of 300 mA/cm² or more, 400 mA/cm² or more, 500 mA/cm² or more, or 600 mA/cm² or more.

TABLE 3
Typical process values for the electrochemical preparation of illustrative
nitride-forming alkali metals or alkaline earth metals and of H₂
(Haber-Bosch process)

| | Thermodynamic | Typical cell | Faraday efficiency | Current density |
|---|---|---|---|---|
| | voltage [V] | voltage [V] | [%] | [mA/cm²] |
| H₂ | 1.23 | 2.10 | 98 | 1500 |
| Li | 4.04 | 6.70-7.50 | 85-94 | 600 |
| Mg | 3.72 | 6.40 | 80 | 600-1200 |
| Ca | 4.23 | 6.90 | 80-91 | 400-1700 |

In particular embodiments, the cathode includes at least 5% by weight, at least 8% by weight, or at least 10% by weight, of the nitride-forming metal. In this case, however, attention should be paid to the melting point of the metal M with respect to the electrolyte temperature, for example of a molten electrolyte, and the melting point of the metals may be higher. This condition is comfortably satisfied, for example, for the following metals M: (a.) Magnesium 650° C., (b.) Calcium 842° C., (c.) Strontium 777° C., (d.) Barium 727° C., (e.) Aluminum 660° C.

This is not necessarily the case for the elements zinc (420° C.) and lithium (180° C.), but these may be present in the cathode, for example, as a constituent of an alloy.

The preparation of the nitride of the metal M by reaction of the electrolytically prepared metal M with a gas including nitrogen is not particularly restricted, and may include combustion of the metal M in a gas including nitrogen, bubbling of a gas including nitrogen, (e.g., pure nitrogen), through liquid metal M, etc. In chemical terms, this act is an oxidation of the metal M by nitrogen, e.g., in a thermal process. A thermal process may be provided in order to generate sufficiently high reaction rates. The temperature for the reaction of the metal M with nitrogen, however, is not particularly restricted and may be matched to the respective metal M with which the reaction with nitrogen is effected.

In particular embodiments, the nitride of the metal M is prepared by combusting the metal M in a gas including nitrogen. This is not particularly restricted. The nitrogen-including gas used may be air, or a gas wherein the oxygen is separated off. In certain embodiments, the nitrogen-including gas is an enriched nitrogen having more than 90%, 95% or 99% by volume of nitrogen, for example, including essentially pure nitrogen or pure nitrogen. The combustion may take place in the absence of oxygen, e.g., with nitrogen having more than 90%, 95% or 99% by volume of nitrogen, for example, including essentially pure nitrogen or pure nitrogen.

The nitride of the metal M formed in the reaction may be suitably collected and subsequently introduced into the electrolysis cell, especially into an anode environment or an anode space of the electrolysis cell. The introduction is not particularly restricted, and may include introduction into a melt, an ionic liquid and/or a solution, as described above.

The converting of the nitride of the metal M at the anode of the electrolysis cell to ammonia is likewise not particularly restricted. More particularly, the reaction is effected here with hydrogen or protons that are formed at the anode. For this purpose, for example, it is possible to use a hydrogen-depolarized anode.

In particular embodiments, the anode takes the form of a hydrogen-depolarized electrode. The term “hydrogen-depolarized electrode” is chosen here analogously to the oxygen-depolarized cathode in chloralkali electrolysis. In the hydrogen-depolarized electrode, gaseous hydrogen is sucked in and reacted by the electrode. The electrode is thus an anode at which the following reaction proceeds:

H₂—2e⁻→2H⁺.

This may provide the protons for the release of the ammonia, while the electrons serve for the reduction of the nitride-forming metal at the cathode. According to the embodiment, with regard to the separation of the metal M (for example, floating/sinking/solid), the ammonia may be drawn off at the anode.

The conversion to ammonia is effected here as follows:

N³⁻+3/2H₂→NH₃+3e⁻

For a reaction of lithium nitride, for example, with hydrogen, when Li is used as metal M, the resultant reaction at the cathode with deposition of lithium is:

Li₃N+3/2H₂→NH₃+3Li

A hydrogen-depolarized anode is advantageous because release of the ammonia does not require any proton provider such as water or alcohol, which contaminates the electrolyte with oxygen-containing species. In such an arrangement, therefore, continuous operation of the electrolyte with constant composition is possible. Contamination of NH₃ with H₂ is uncritical. Moreover, PEM and alkali hydrogen electrolyzers are state of the art and have an efficiency of >60%.

Such electrodes are known from fuel cell technology over the entire temperature range and are not particularly restricted. These may include carbon-containing materials with or without precious metal catalyst coating or addition, (e.g., Pd, Pt). Examples of suitable electrodes as anodes at temperatures of <250° C. are described in “Electrocatalytic hydrogenation of o-xylene in a PEM reactor as a study of a model reaction for hydrogen storage”, Takano, K., Tateno, H., Matsumura, Y., Fukazawa, A., Kashiwagi, T., Nakabayashi, K., Nagasawa, K., Mitsushima, S. & Atobe, M. 2016 in: Chemistry Letters, 45, 12, p. 1437-1439 and “Electrocatalytic hydrogenation of toluene using a proton exchange membrane reactor”, Takano, K., Tateno, H., Matsumura, Y., Fukazawa, A., Kashiwagi, T., Nakabayashi, K., Nagasawa, K., Mitsushima, S. & Atobe, M. 2016 in: Bulletin of the Chemical Society of Japan, 89, 10, p. 1178-1183. In the event of a change in the binder, these are also suitable for high temperatures.

For higher temperatures, the materials of the solid oxide fuel cells (SOFCs) or solid oxide electrolytic cells (SOECs) are suitable, as described above. The overvoltages on the “hydrogen side” of such electrochemical cells are very small, such that, in conjunction with the deposition of the nitride-forming metal, a process act may be configured with low overvoltages.

The ideal cell voltage here may be calculated as follows, using the example of lithium.

The overall reaction equation for the cell reads:

Li₃N+3/2H₂→NH₃+3Li.

The enthalpy of formation of ammonia is −46.1 kJ/mol, that of lithium nitride −207 kJ/mol. This results in the relatively low energy expenditure of 160.9 kJ/mol for the reaction. This may be converted to a minimum cell voltage of 0.56 V by dividing by z·F, with z=3 and F=96485.309 C/mol. The very low cell voltage compared to Table 3 arises from the avoidance of chlorine formation at the anode and from use of the hydrogen-depolarized anode.

The hydrogen required for the conversion to ammonia may likewise be obtained electrochemically in particular embodiments. The mediator may be circulated without high energy expenditure in this way. In principle, the mediator may also be considered to be a seasonal or locally free energy storage device or component. The release of the ammonia, linked to a renewable energy source and/or nitride preparation, may be effected at a different site—linked, for example, to a site requiring energy, for example from the reaction of the metal M with nitrogen.

Another conceivable alternative is a hydrogen oxidation anode, in which case, however, oxygen could form, which (if oxygen should diffuse through the hydrogen oxidation anode, even though it should actually form beyond the gas diffusion electrode) may form an explosive NH₃/O₂ gas that may ignite over the catalysts.

While the electrochemical reduction of N₂ to nitride is strongly kinetically inhibited, thermochemical formation with the corresponding moderator, the metal M, is readily possible. Possible configurations for plants for reacting the metal M with nitrogen are described in DE102014209527.1 or DE102014219274.9, to which reference is made with regard to the reaction of metal M with nitrogen. The temperature levels may even be so high that the resultant energy may be utilized in a power plant or for raising steam. In particular embodiments, the energy generated in the reaction of the metal M with nitrogen is therefore used for generation of power and/or for raising steam. Correspondingly, the metal M here may thus serve as a storage for energy, (e.g., power), when the electrolysis cell is operated with renewable energy.

In a further aspect, the present disclosure relates to an apparatus for preparation of ammonia. The apparatus includes an electrolysis cell having: a cathode space including a cathode for preparation of a metal M, where M is selected from Li, Mg, Ca, Sr, Ba, Zn, Al, and/or alloys and/or mixtures thereof, where the cathode is designed to prepare a metal M; a separation apparatus set up to separate the metal M from the cathode; a first removal apparatus for the metal M which is connected to the cathode space and designed to remove the metal M from the electrolysis cell; a second feed device for a nitride of the metal M, which is set up to feed a nitride of the metal M to the electrolysis cell, (e.g., an anode space of the electrolysis cell); and an anode space including an anode for preparation of ammonia from the nitride of the metal M, where the anode is designed to prepare ammonia from the nitride of the metal M. The apparatus also includes a preparation apparatus for preparation of a nitride of the metal M by reacting the electrolytically prepared metal M with a gas including nitrogen. The preparation apparatus includes a reaction apparatus for reacting the metal M with a gas including nitrogen, designed to react the metal M with a gas including nitrogen; a first feed device for the metal M, designed to feed the metal M to the apparatus for conversion of the metal M; and a second removal device for a nitride of the metal M, designed to remove a nitride of the metal M from the apparatus for conversion of the metal M.

The apparatus of the disclosure may be used to perform the process of the disclosure, and so corresponding embodiments of the process of the disclosure may also be employed in the apparatus of the disclosure.

In the apparatus, the electrolysis cell is not particularly restricted in that it includes a cathode space having a cathode, an anode space having an anode, a separation apparatus for the metal M, a first removal apparatus for the metal M, and a second feed device for a nitride of the metal M.

The respective feed and removal devices in the apparatus are likewise not particularly restricted and may be provided, for example, as suitable conduits, for example, pipes, hoses, etc.

In the electrolysis cell, the cathode and the anode are not particularly restricted.

In particular embodiments, the anode takes the form of a hydrogen-depolarized electrode. This may include carbon-containing materials with or without precious metal catalyst coating or addition, (e.g., Pd, Pt). Examples of suitable electrodes as anodes at temperatures of <250° C. are described in “Electrocatalytic hydrogenation of o-xylene in a PEM reactor as a study of a model reaction for hydrogen storage”, Takano, K., Tateno, H., Matsumura, Y., Fukazawa, A., Kashiwagi, T., Nakabayashi, K., Nagasawa, K., Mitsushima, S. & Atobe, M. 2016 in: Chemistry Letters, 45, 12, p. 1437-1439 and “Electrocatalytic hydrogenation of toluene using a proton exchange membrane reactor”, Takano, K., Tateno, H., Matsumura, Y., Fukazawa, A., Kashiwagi, T., Nakabayashi, K., Nagasawa, K., Mitsushima, S. & Atobe, M. 2016 in: Bulletin of the Chemical Society of Japan, 89, 10, p. 1178-1183. In the event of a change in the binder, these are also suitable for high temperatures. For higher temperatures, the materials of the solid oxide fuel cells (SOFCs) or solid oxide electrolytic cells (SOECs) are suitable, as described above.

In particular embodiments, the cathode is in porous form. In particular embodiments, the cathode includes the metal M, (for example, when the metal is removed in solid form), and/or includes a metal and/or a material such as carbon, etc., which has sufficient conductivity and is in solid form at the electrolysis temperature. Because this temperature depends on the metal M, according to the metal M, various materials are therefore also conceivable for the cathode, which, furthermore, are not subject to any further restriction. For example, pure iron is also suitable. By contrast, lithium forms an alloy with copper, for example, and would therefore only be of limited suitability for deposition of lithium. Correspondingly, the cathode may be matched to the metal M.

In particular embodiments, the cathode includes at least 5% by weight, e.g. at least 8% by weight, for example more than 10% by weight, of the nitride-forming metal. In this case, however, attention should be paid to the melting point of the metal M with respect to the electrolyte temperature, for example of a molten electrolyte, and the melting point of the metals may be higher. This condition is comfortably satisfied, for example, for the following metals M: (a.) Magnesium 650° C., (b.) Calcium 842° C., (c.) Strontium 777° C., (d.) Barium 727° C., (e.) Aluminum 660° C.

This is not necessarily the case for the elements zinc (420° C.) and lithium (180° C.), but these may be present in the cathode, for example, as a constituent of an alloy.

The separation apparatus for the metal M is not particularly restricted either and may be matched, for example, to a state of matter of the deposited metal M. If, for example, the metal M is deposited in solid form, the separation apparatus may be provided, for example, in the form of a stripper. If, by contrast, the metal M is formed in liquid form, the separation apparatus may be a separation apparatus that separates the metal M at the top or bottom at the base of the electrolysis cell, for example in a Downs cell, a Castner cell and/or a corresponding electrolysis cell in aluminum electrolysis. In such embodiments, the electrolysis cell may thus be formed analogously to a Downs cell, a Castner cell and/or a corresponding electrolysis cell in aluminum electrolysis. The Downs cell, Castner cell or any electrolysis cell for aluminum production are known to the person skilled in the art and are not particularly restricted.

In particular embodiments, the first removal device for the metal M is designed so as to remove the metal M as floating liquid, for example in a Downs cell.

In particular embodiments, the first removal device for the metal M is designed so as to remove the metal M in liquid form from the base of the electrolysis cell, for example in an electrolysis cell for aluminum production.

The separation apparatus in a porous cathode may also be provided in the form of a suction apparatus so as to suck the liquid metal M out of the cathode, for example by using one or more suitable pumps and corresponding conduits, etc.

The metal M, however, may also occur in solid form and may be obtained, for example, by exchanging the electrodes and/or stripping off from the electrodes.

Furthermore, the electrolysis cell may also include a third feed device for a gas including H₂, (e.g., essentially H₂ or pure H₂), which may be configured to supply hydrogen to the anode space, e.g., the anode. The anode may take the form of a gas diffusion electrode, (e.g., a hydrogen-depolarized electrode), at which hydrogen may be converted to protons, and the protons are reacted with nitride ions to give ammonia. The electrolysis cell may also include a second removal device for ammonia, designed to remove ammonia from the electrolysis cell, for example, on the anode side or from the anode space.

In the electrolysis cell, the anode space and the cathode space may be connected or separated, for example, by a suitable separator, e.g. a cation-conducting membrane (CEM, cation exchange membrane).

As in a plant for preparation of aluminum, etc., it is also possible for multiple electrodes, (e.g., multiple anodes) (for example, in the case of a liquid cathode) and/or cathodes to be disposed in an electrolysis cell, or it is possible for multiple stacks and/or electrolysis cells to remove the metal M via multiple first removal apparatuses, in which case the metal M from all these first removal apparatuses is also supplied via a first feed device, for example a combined first feed device, of the apparatus for preparation of a nitride of the metal M, or vice versa.

In particular embodiments, the electrolysis cell includes at least one heating device designed to heat an electrolyte in the electrolysis cell, (e.g., to a temperature above the melting point of the metal M). This is advantageous especially when starting up the electrolysis cell, for example in order to melt a salt melt as electrolyte.

Nor is there any particular restriction in the apparatus for preparation of a nitride of the metal M by reaction of the electrolytically prepared metal M with a gas including nitrogen, including: a reaction apparatus for reaction of the metal M with a gas including nitrogen, designed to react the metal M with a gas including nitrogen; a first feed device for the metal M, designed to feed the metal M to the apparatus for conversion of the metal M; and a second removal device for a nitride of the metal M, designed to remove a nitride of the metal M from the apparatus for conversion of the metal M.

It may be configured, for example, as a reactor to which the metal M is supplied via the first feed device and is then reacted with a gas including nitrogen, e.g. air, essentially pure nitrogen or pure nitrogen, for example, by bubbling through liquid metal M or combusting the metal M in the gas including nitrogen. In the case of a combustion, it is correspondingly possible for the apparatus for preparation of a nitride of the metal M to include a burner, at least one nozzle for supply of the metal M and/or the gas including nitrogen, etc. In particular embodiments, the apparatus for reaction of the metal M with a gas including nitrogen includes a device for combustion of the metal M, designed to combust the metal M.

The apparatus for preparation of a nitride of the metal M further includes the second removal device for a nitride of the metal M, which is not particularly restricted and, in particular embodiments, is connected to the second feed device for a nitride of the metal M. However, it is not ruled out that the nitride of the metal M is transported in another way, stored, etc., between the second removal device and the second feed device, for example in order to adjust the supply of the nitride of the metal M to an availability of renewable energy for the electrolysis cell.

In particular embodiments, the apparatus for preparation of a nitride of the metal M is additionally designed to remove and utilize waste heat formed in the reaction, for example for power generation and/or steam raising. For this purpose, for example, it is possible to provide heat exchangers, turbines, etc.

The above embodiments, configurations, and developments may, if viable, be combined with one another as desired. Further possible configurations, developments, and implementations also include combinations that have not been specified explicitly of features of the disclosure that have been described above or are described hereinafter with regard to the working examples. More particularly, the person skilled in the art will also add on individual aspects as improvements or additions to the respective basic form of the present disclosure.

The disclosure will be elucidated further in detail hereinafter with reference to various examples thereof. However, the disclosure is not limited to these examples.

### EXAMPLES

### Example

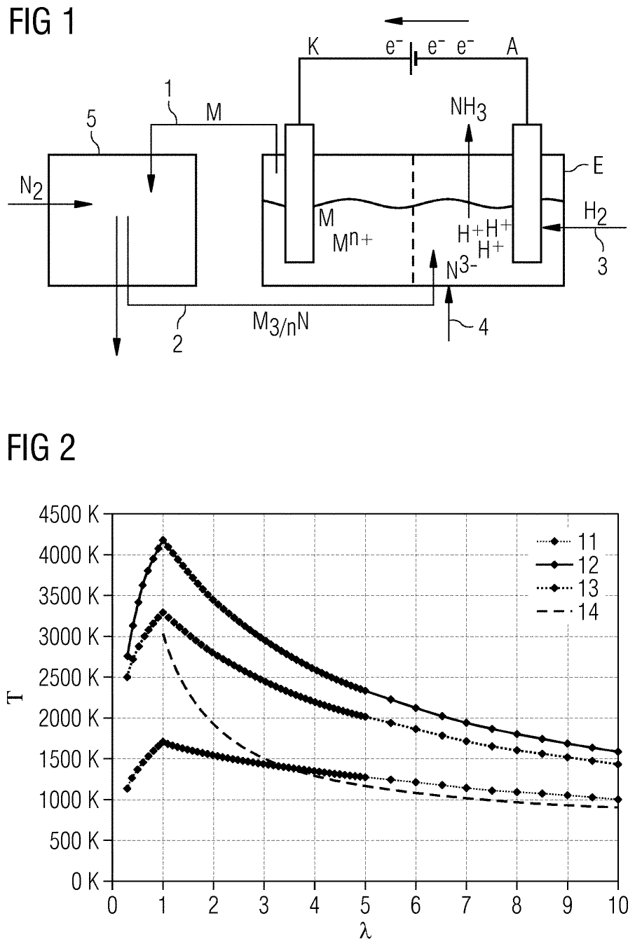

A first illustrative embodiment is shown in FIG. 1.

In this embodiment, the metal M is produced from metal cations Mⁿ⁺ at the cathode K of the electrolysis cell E, and fed via the first removal device 1 to the apparatus 5 for preparation of a nitride of the metal M. The metal nitride M_{3/n}N formed in the apparatus 5 is fed via the second feed device 2 to the anode space of the electrolysis cell E. The third feed device is additionally used to guide hydrogen to the anode A, which reacts there to give protons. The protons react with nitride ions N³⁻ in the electrolyte 4 of the electrolysis cell E to give ammonia, which may escape. Thermal energy may also be created in the apparatus 5, which may be removed from the apparatus 5. The metal M in the electrolysis cell may be separated off in a suitable manner, for example, by virtue of the cathode K being in porous form and the metal M being sucked out of it.

### Reference Example 2

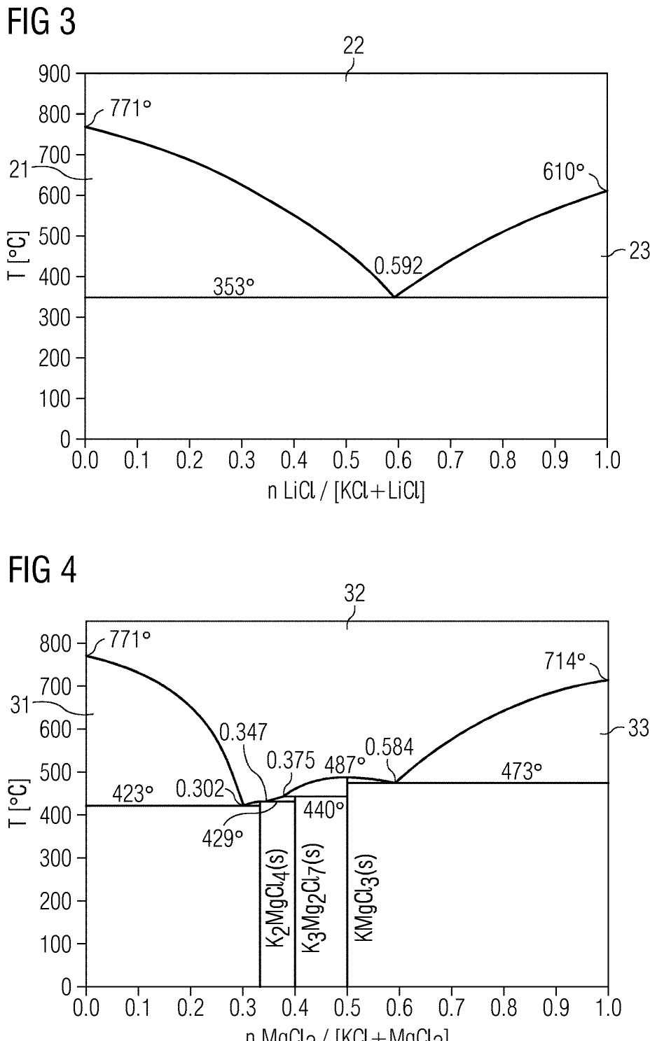

For various metals M, combustion in an apparatus for preparation of a nitride of the metal M by reaction of the electrolytically prepared metal M with nitrogen results in various flame temperatures which have to be correspondingly taken into account in the apparatus for preparation of the nitride of the metal M, and correspondingly also may have to be considered in the event of a further energy release. This is shown by way of example for various mixtures of metal M with nitrogen in FIG. 2, where the ratio λ between reaction gas and fuel (metal M) is shown on the x axis and the adiabatic flame temperature T (in K) on the y axis. FIG. 2 shows curve 11 for a mixture of Li and nitrogen, curve 12 for a mixture of Mg and nitrogen, and curve 13 for a mixture of Ca and nitrogen, and, by way of comparison, curve 14 for a mixture of methane and air. An assumption here is that the reaction gas has been heated to 400° C., neglecting changes in phase, the alkali metals and alkaline earth metals have been preheated to the melting point, and the dependence between specific heat capacity and temperature is taken into account. It is apparent from the figure that, in the case of combustion of the metals M with nitrogen, a very large amount of heat is released, which may be used to obtain power and/or steam.

### Reference Example 3

In addition, considerations have been made as to which electrolytes may be used in a process for the electrolyte temperature to remain below the decomposition temperature of ammonia.

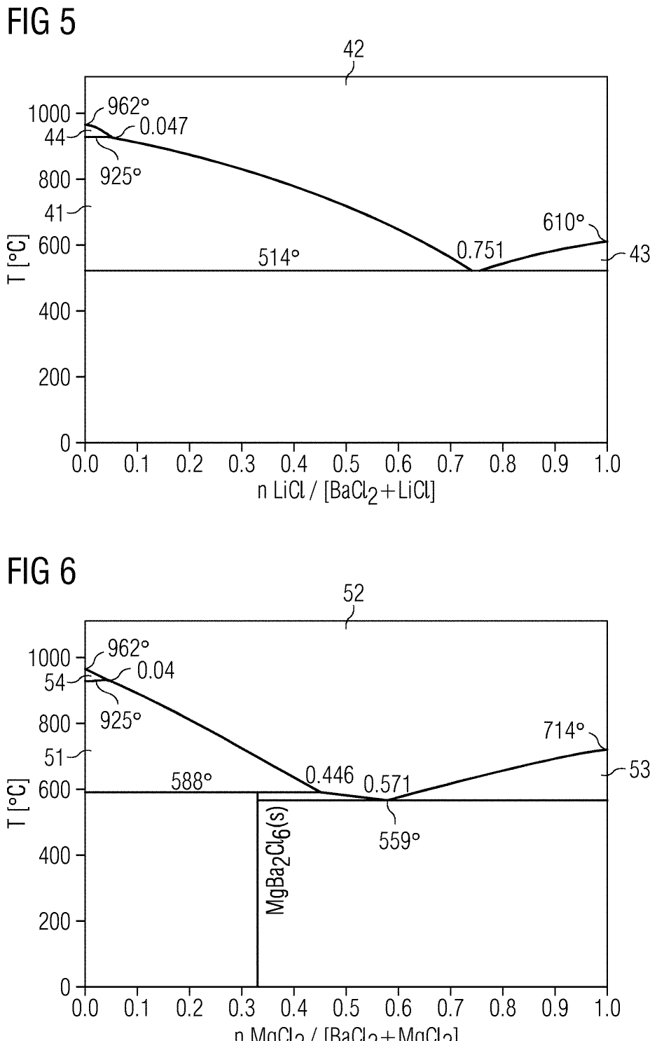

Phase diagrams that have been created with FactSage with data from the FTsalt FACTsalt database for examples of suitable salt melts are shown in FIGS. 3 to 6, with FIG. 3 showing mixtures of LiCl and KCl, FIG. 4 mixtures of KCl and MgCl₂, FIG. 5 mixtures of BaCl₂ and LiCl, and FIG. 6 mixtures of BaCl₂ and MgCl₂. What is plotted in each case is the molar ratio n against temperature T in ° C.

For all four mixtures shown, suitable temperatures are found for salt melts, and it is possible here especially with LiCl—KCl, especially as a eutectic mixture, to achieve a low temperature of the salt melt.

The figures additionally also show the following phases that are not specified in the figures:
21: salt melt+KCl(s)
22: salt melt
23: salt melt+LiCl(s)
31: salt melt+KCl(s)
32: salt melt
33: salt melt+MgCl₂(s)
41: salt melt+BaCl₂ (s)
42: salt melt
43: salt melt+LiCl(s)
44: salt melt+BaCl₂ (s2)
51: salt melt+BaCl₂ (s)
52: salt melt
53: salt melt+MgCl₂ (s)
44: salt melt+BaCl₂ (s2)

The one-stage electrochemical reduction of nitrogen to ammonia is current-limited by the reduction of nitrogen at the cathode in all temperature ranges up to 700° C. If anything, current densities in the region of a few mA/cm² are achieved.

By contrast, current densities of 100 mA/cm² to more than 1 A/cm² may be achieved by the process. The process here especially has the following advantages.

(1.) For one advantage, the cathode reaction does not limit the industrial current density achievable. A nitride-forming metal M is produced at the cathode and circulated. The mediator, the metal M, may simultaneously be considered as an energy storage.

Mⁿ⁺+ne⁻→M

n=1,2,3

(2.) In a second advantage, nitride formation takes place outside the electrolysis cell. The resultant thermal energy may be converted back to power or used to raise steam.

M+N₂→2(Mⁿ⁺)_{3/n}N³⁻

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A process for preparing ammonia, the process comprising:
electrolytically preparing a metal at a cathode of an electrolysis cell, wherein the metal is selected from the group consisting of Li, Mg, Ca, Sr, Ba, Zn, Al, alloys thereof, and mixtures thereof;
preparing a nitride of the metal by reacting the electrolytically prepared metal with a gas comprising nitrogen;
introducing the nitride of the metal into the electrolysis cell; and
converting the nitride of the metal to ammonia at an anode of the electrolysis cell.

2. The process of claim 1, wherein the electrolyte in the electrolysis cell comprises one or more of a salt melt, an ionic liquid, or a solution of salts in an organic solvent.

3. The process of claim 1, wherein the nitride of the metal is prepared by combusting the metal in the gas comprising nitrogen.

4. The process of claim 3, wherein the electrolytic preparation of the metal is effected by depositing the metal at the cathode and the metal is separated from the cathode before the metal is reacted with the gas comprising nitrogen.

5. The process of claim 4, wherein the metal is separated off in liquid form.

6. The process of claim 5, wherein the cathode is in porous form and the metal is drawn off in an interior of an electrode.

7. The process of claim 1, wherein the anode is a hydrogen-depolarized electrode.

8. The process of claim 1, wherein energy generated in the reaction of the metal with the nitrogen is used to generate power and/or raise steam.

9. An apparatus for preparation of ammonia, the apparatus comprising:
an electrolysis cell comprising:
a cathode space comprising a cathode configured to electrolytically prepare a metal, wherein the metal is selected from the group consisting of Li, Mg, Ca, Sr, Ba, Zn, Al, alloys thereof, and mixtures thereof;
a separation apparatus configured to separate the metal from the cathode;
a first removal apparatus for the metal which is connected to the cathode space and configured to remove the metal from the electrolysis cell;
a second feed device for a nitride of the metal M, which is configured to feed a nitride of the metal to the electrolysis cell;
an anode space comprising an anode, wherein the anode is configured to prepare ammonia from the nitride of the metal; and
a preparation apparatus for preparation of a nitride of the metal by reacting the electrolytically prepared metal with a gas comprising nitrogen, the preparation apparatus comprising:
a conversion apparatus configured to react the metal with the gas comprising nitrogen;
a feed device for the metal, wherein the feed device is configured to feed the metal to the conversion apparatus for conversion of the metal M; and
a removal device for a nitride of the metal,
wherein the removal device is configured to remove a nitride of the metal from the conversion apparatus.

10. The apparatus of claim 9, wherein the conversion apparatus for reacting the metal with the gas comprising nitrogen comprises a combustion apparatus configured to combust the metal.

11. The apparatus of claim 9, wherein the cathode is in porous form.

12. The apparatus of claim 9, wherein the anode is a hydrogen-depolarized electrode.

13. The apparatus of claim 9, further comprising:
a heating device configured to heat an electrolyte in the electrolysis cell.

14. The apparatus of claim 9, wherein the removal device for the metal is configured to remove the metal as a floating liquid.

15. The apparatus of claim 9, wherein the removal device for the metal is configured to remove the metal M in liquid form from a base of the electrolysis cell.

16. The apparatus of claim 13, wherein the heating device is configured to heat the electrolyte to a temperature above a melting point of the metal.

17. The process of claim 1, wherein the nitride of the metal is introduced into an anode space of the electrolysis cell.

18. The process of claim 1, wherein the electrolytic preparation of the metal is effected by depositing the metal at the cathode and the metal is separated from the cathode before the metal is reacted with the gas comprising nitrogen.

19. The process of claim 18, wherein the metal is separated off in liquid form.

20. The process of claim 19, wherein the cathode is in porous form and the metal is drawn off in an interior of an electrode.
